(19) United States
(12) Patent Application Publication
(10) Pub. No.: US 2024/0207976 A1
(43) Pub. Date: Jun. 27, 2024

(54) METHOD FOR CUTTING AT LEAST ONE WORKPIECE FROM A METAL SHEET

(71) Applicant: TRUMPF Werkzeugmaschinen SE + Co. KG, Ditzingen (DE)

(72) Inventors: Stefan Krause, Wilthen (DE); Patrick Mach, Korb (DE)

(21) Appl. No.: 18/599,402

(22) Filed: Mar. 8, 2024

Related U.S. Application Data
(63) Continuation of application No. PCT/EP2022/073912, filed on Aug. 26, 2022.

(30) Foreign Application Priority Data
Sep. 10, 2021 (DE) 10 2021 123 520.0

(51) Int. Cl. B23K 26/38

(52) U.S. Cl. CPC B23K 26/38

(57) ABSTRACT

A method for cutting at least one workpiece from a metal sheet includes arranging a metal sheet on a support of a laser cutting machine, and directing a laser beam onto the metal sheet along an outline of the workpiece. The metal sheet is cut through in a main region of the outline. At least one connecting portion, which has a height that is less than a thickness of the metal sheet, remains in at least one connection region of the outline between the workpiece and an adjoining part of the metal sheet. The method further includes removing the at least one workpiece and the adjoining part connected thereto from the support, and separating the at least one workpiece from the adjoining part.

### CROSS REFERENCE TO RELATED APPLICATIONS

This application is a continuation of International Application No. PCT/EP2022/073912 (WO 2023/036640 A1), filed on Aug. 29, 2022, and claims benefit to German Patent Application No. DE 10 2021 123 520.0, filed on Sep. 10, 2021. The aforementioned applications are hereby incorporated by reference herein.

### FIELD

Embodiments of the present invention relate to a method for cutting at least one workpiece from a metal sheet arranged on a support of a laser cutting machine.

### BACKGROUND

Laser cutting methods in which workpieces are cut from a metal sheet are generally known. For cutting the workpieces, the metal sheet is typically arranged on a support of a laser cutting machine. The support often has webs which are spaced apart from one another, so that the metal sheet is not supported over its entire surface. Therefore, there is therefore a risk that, in particular smaller, workpieces tilt after cutting. This can lead to the workpieces not being able to be removed in an automated manner or getting jammed in a sheet skeleton of the metal sheet.

From US 2018/0093348 A1, it is known to cut workpieces only partially so that they remain connected to a sheet skeleton unit. The sheet skeleton unit is completely separated from the metal sheet, so that the sheet skeleton unit can be removed together with the component(s) connected thereto. In order to obtain the connecting portion between the respective workpiece and the sheet skeleton unit, the laser beam is interrupted. The metal sheet is therefore not irradiated and processed by the laser beam in the region of the connecting portions.

The connecting portions obtained with the method described in US 2018/0093348 A1 extend over the entire thickness of the metal sheet. Such connecting portions are also referred to as “microjoints.” Due to the height of the connecting portions comprising the entire thickness of the metal sheet, it is complicated to separate the workpieces from the respective sheet skeleton unit. In addition, after the laser beam has been interrupted for producing the connecting portions, the metal sheet has to be pierced again. On the one hand, this is time-consuming. On the other hand, a piercing spot directly at the workpiece generally results in a locally reduced cutting edge quality. Often, therefore, it does not need to be pierced directly at the workpiece.

### SUMMARY

Embodiments of the present invention provide a method for cutting at least one workpiece from a metal sheet. The method includes arranging a metal sheet on a support of a laser cutting machine, and directing a laser beam onto the metal sheet along an outline of the workpiece. The metal sheet is cut through in a main region of the outline. At least one connecting portion, which has a height that is less than a thickness of the metal sheet, remains in at least one connection region of the outline between the workpiece and an adjoining part of the metal sheet. The method further includes removing the at least one workpiece and the adjoining part connected thereto from the support, and separating the at least one workpiece from the adjoining part.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a laser cutting machine configured to carry out the laser cutting method according to embodiments of the invention;

FIGS. 2a and 2b show a workpiece laser-cut from a metal sheet, which workpiece is held by nanojoints on an adjoining part, in a plan view (FIG. 2a), and in a sectional view (FIG. 2b) corresponding to IIb-Ilb in FIG. 2a, according to some embodiments;

FIG. 3 shows a metal sheet with four groups of workpieces which are each connected to a common sheet skeleton part of the group via a nanojoint, during a method according to embodiments of the invention, in a schematic plan view;

FIG. 4 shows a metal sheet with two groups of workpieces which are each connected to a common remaining part of the group via a nanojoint, and with further individually cut sheet metal parts, during a method according to embodiments of the invention, in a schematic plan view;

FIG. 5 shows a further metal sheet having two groups of workpieces which are each connected to a common remaining part of the group via a nanojoint, and with further, individually cut sheet metal parts, during a method according to embodiments of the invention, in a schematic plan view;

FIG. 6 shows a metal sheet with a group of workpieces connected to one another via nanojoints, during a method according to embodiments of the invention, in a schematic plan view; and

FIG. 7 shows a schematic flowchart of a method according to embodiments of the invention.

### DETAILED DESCRIPTION

Embodiments of the invention provide a method by means of which high-quality sheet metal workpieces can be produced efficiently—in particular, in a reliably automatable and simple process.

According to embodiments of the invention, a method for cutting at least one workpiece from a metal sheet is provided. The metal sheet typically consists of metal. The metal sheet can in particular consist of steel. A thickness of the metal sheet can be at least 2 mm—preferably at least 4 mm. The thickness of the metal sheet can be at most 40 mm—preferably at most 30 mm.

The procedure comprises the steps of
A) arranging a metal sheet on a support of a laser cutting machine;
B) directing a laser beam onto the metal sheet along an outline of the workpiece, wherein the metal sheet is cut through in a main region of the outline, and wherein at least one connecting portion remains in at least one connection region of the outline between the workpiece and an adjoining part of the metal sheet, which connecting portion has a height which is smaller than a thickness of the metal sheet;
C) removing the at least one workpiece and the adjoining part connected thereto from the support;
D) separating the workpiece from the adjoining part.

In principle, steps A) to D) are carried out in the order indicated.

In step A), the metal sheet is placed on the support of the laser cutting machine. The metal sheet can be fixed to the support. The support typically has discrete support means, e.g., webs running in parallel and spaced apart from one another, for a locally limited support of the metal sheet.

In step B), a laser beam is directed onto the metal sheet. The laser beam can be emitted by a machining head of the laser cutting machine. The point of incidence of the laser beam on the metal sheet is moved along an outline of the workpiece. For this purpose, the machining head can be moved relative to the support. Together with the laser beam, a jet of cutting gas, e.g., nitrogen and/or oxygen, can be directed onto the metal sheet along the outline. The laser beam and the cutting gas jet can exit together from a cutting gas nozzle of the machining head. The outline corresponds to an outer contour of the workpiece. The movement along the outline can be closed (without interruptions) or take place in a plurality of sections separated in time. In principle, the laser beam is not switched off during the movement along the outline. Material is removed at every point of the outline.

The metal sheet is cut through in a main region of the outline. The main region typically comprises more than 90%, preferably more than 95%, and preferably more than 98% of the length of the outline. In at least one connection region of the outline, at least one connecting portion remains between the workpiece and an adjoining part of the metal sheet, which connecting portion has a height that is less than a thickness of the metal sheet. Such a connecting portion is also referred to below as a “nanojoint” or as a “connecting portion of low height.” In principle, the connecting portion is formed on the side of the metal sheet facing away from the point of incidence of the laser beam. In other words, the at least one workpiece remains connected to at least one further workpiece or a sheet skeleton part, wherein the connecting portion does not extend over the entire thickness of the metal sheet or the workpiece. By connecting it to the adjoining part, tilting of the workpiece can be prevented.

Preferably, the laser power is reduced in the connection region of the outline in order to obtain the connecting portion of low height. Alternatively or additionally, a cutting speed can be increased, or a distance between a cutting gas nozzle through which the laser beam and a cutting gas jet are directed onto the metal sheet or the workpiece can be increased. Due to these parameter changes, a complete cutting through of the metal sheet is avoided locally. The parameter change(s) for producing the connecting portion of low height can take place as described in WO 2019/025327 A2. In this respect, reference is made to the description in WO 2019/025327 A2, wherein the connecting portions referred to here as connecting portions of low height or “nanojoints” are referred to as “microjoints” in WO 2019/025327 A2.

In step C), the at least one workpiece is removed from the support together with the adjoining part, which is connected to the workpiece via the at least one connecting portion of low height. Due to the connecting portion of the at least one workpiece and the adjoining part, this can take place easily. A removal device does not need to engage each workpiece, but only at one or possibly several suitable locations of the compound, wherein the number of engagement points is typically less than the number of workpieces to be removed together. This accelerates the removal process. The removal device may have a vacuum gripper, a magnet gripper, a Bernoulli gripper, and/or a mechanical gripper—in particular, a tongs gripper. The nanojoints ensure that, on the one hand, the workpieces are sufficiently held together or in the sheet skeleton part and, on the other, can nevertheless be separated easily, e.g., manually, from one another or from the sheet skeleton part.

Then, in step D), the at least one workpiece is separated from the adjoining part. In other words, the workpieces are singularized from one another. Due to the low height of the connecting portion, the separation can take place easily—in particular, with little use of force. In addition, thanks to the low height of the connecting portion, a largely unimpaired edge is obtained on the separated workpiece, i.e., a workpiece of good quality is obtained. The separation can take place manually—for example, by pressing with the fingers or by knocking with a hammer. Preferably, the separation takes place in an automated manner. If a plurality of workpieces have been removed together, the plurality of workpieces can be separated in a single operation. The method is thereby further accelerated. The separation can take place by vibrating, pressing, blowing out, or pulling—in particular, magnetic pulling or pulling by means of negative pressure. Vibrating is understood here to mean, in particular, a repeated back-and-forth movement. During vibrating, at least one pulse can be introduced into the compound.

A separating device for separating the workpiece from the part connected to it via the nanojoint may be formed at the removal device—in particular, integrated into the removal device. Alternatively, the removal device and the separating device may be provided separately from one another. The separating device may, for example, be a push-out device with a push-out pin movable, in particular, by a pneumatic cylinder. For separation by vibrating, separate separating device is not necessarily needed. The compound held together by the connecting portions of low height can, for example, be shaken by the removal device so that the at least one workpiece detaches from the adjoining part. The nanojoints break in this process.

For the separation, the removal device can move with the compound containing the workpiece over a finished-part tray. After the separation, the good parts are located on or in the finished-part tray. An optionally remaining skeleton part can be deposited on a separate tray.

The method according to embodiments of the invention also has the advantage that the cutting kerf, in which the nanojoint is arranged, can be very narrow. In particular, if a plurality of workpieces have common separating cuts and are to be held together as a compound on the support by the connecting portions (so that the individual parts do not tilt), this can be realized only via a nanojoint. When producing microjoints (which extend over the entire thickness of the metal sheet or the workpiece), the laser beam has to be switched off, so that, subsequently, for further cutting between the workpieces, a piercing would have to take place directly at these good parts, which is usually not possible. The narrow kerf also has the advantage that a vacuum suction device (vacuum gripper) of a removal device would not necessarily have to engage either in a sheet skeleton region without cutting lines or at a sufficiently large workpiece, but could extend over the kerf without the suction effect becoming too low. In this way, it is not absolutely necessary to provide special regions for the suction cup positioning.

A height of the connecting portion of low height can be at most one third, preferably at most one quarter, and preferably at most one sixth of the thickness of the metal sheet. Typically, the height of the connecting portion is at least one twentieth, and in particular, at least one tenth, of the thickness of the metal sheet. A length of the connecting portion of low height, the length being measured along the outline, can be at most half and/or at least one eighth—in particular, at least one quarter—of the thickness of the metal sheet. With a connecting portion dimensioned in this way, the workpiece can, on the one hand, be securely held and, on the other, easily separated.

In an advantageous variant of the method, a group of workpieces is formed in step B), which are connected to one another via connecting portions of low height at at least one common outline line of the workpieces. In other words, the workpieces have common cutting edges, wherein at least one nanojoint is arranged in each common cutting edge. Such a group of workpieces can also be referred to as a “nest.” This variant makes use of the fact that, after producing the connecting portion of low height, it is not necessary to pierce again. The connecting portion can therefore be formed between two workpieces (good parts). The common outline line also enables a space-saving arrangement of the workpieces on the metal sheet.

The group of workpieces can have a circumferential outer contour, which is formed by outline lines of the workpieces, along which the metal sheet is cut. In other words, the outer contour can be formed by main regions of the outlines of the plurality of workpieces. Thus, a “nest” of interconnected workpieces is obtained, which is completely cut out of the sheet skeleton as a whole. The group of workpieces (the nest) can be removed from the metal sheet as a unit—i.e., without sheet skeleton parts as dead weight.

In step C), a removal device can engage one of the workpieces of the group. Since the load-bearing capacity of a removal device is limited, more workpieces (good parts) can be removed jointly in this way in one step. The maximum parts weight for the nest is preferably 100 kg. The maximum size of the nest can be 1,000 mm×1,500 mm.

In step B), in addition to the at least one workpiece, at least one sheet metal part can be cut out of the metal sheet, which sheet metal part is removed in step C) individually and independently of the at least one workpiece and its adjoining part. This allows flexible use of the metal sheet—in particular, for producing large sheet metal parts which do not have to be secured and can be handled individually, as well as smaller or elongated workpieces which have to be secured and are expediently removed in a compound.

In an advantageous variant of the method, a group of workpieces is formed in step B), each of which remains connected to a common sheet skeleton part via at least one connecting portion of low height. In step C), the plurality of workpieces and the adjoining sheet skeleton part can be removed together. This variant is suitable for small workpieces which cannot be arranged directly adjoining one another.

Preferably, prior to step C), the sheet skeleton part is cut free from the metal sheet—in particular, along a circumferential contour. If the sheet skeleton part is arranged at the edge of the metal sheet, the contour can extend between side points of the metal sheet to be cut free. The contour can be concave. In this way, a plurality of (in particular, smaller and/or slim) workpieces which remain connected to the sheet skeleton part by nanojoints can be distributed on the metal sheet between larger workpieces or sheet metal parts which do not have to be stabilized by nanojoints and the plurality of workpieces are surrounded by a continuous cutting line along the contour. The shape of the contour surrounding the plurality of workpieces of the group can essentially be arbitrarily selected. In particular, a non-square and, in particular, also non-rectangular sheet skeleton part can be separated from the remaining metal sheet. In this way, a material-efficient nesting of the workpieces is possible. The arrangement of the smaller workpieces can be based upon the space available between the larger sheet metal parts on the metal sheet. The contour around the group of the plurality of workpieces is then selected accordingly. In other words, a sheet skeleton part, which can have any shape and, in particular, does not have to be rectangular, is formed around the plurality of workpieces. This sheet skeleton part is cut free from the metal sheet and removed together with the workpieces contained therein.

A smallest distance of the contour from the workpieces of the group can be at least 12 mm. Preferably, the smallest distance is greater than the thickness of the metal sheet—in particular, if the thickness of the metal sheet is more than 15 mm. In this way, it can be avoided that the sheet skeleton part bulge up due to the heat input of the laser cutting.

The sheet skeleton part can have engagement surfaces for grippers of a removal device—in particular, for vacuum grippers. In principle, no cutting lines are introduced into the engagement surfaces. Preferably, on the sheet skeleton part, at least one engagement surface for a removal device with a diameter of at least 120 mm remains free of workpieces. This enables safe handling of larger compounds.

In step C), a removal device can engage the sheet skeleton part. This simplifies removal in the case of very small workpieces. In addition, damage to the workpieces by the removal device is avoided. If the workpieces are separated from the sheet skeleton part while a removal device engages the sheet skeleton part, it can be determined by measuring the weight held by the removal device whether all workpieces have been detached from the sheet skeleton part.

The sheet skeleton part is preferably not smaller than 30 mm×80 mm and not larger than 1,000 mm×1,500 mm. A sheet skeleton part dimensioned in this way can be easily removed by an automated removal device. The maximum weight of the sheet skeleton part together with the workpieces held thereon is preferably at most 100 kg.

The sheet skeleton part with the workpieces contained therein and connected to it via nanojoints can be arranged at the edge of the metal sheet. Thus, the previously unused edge of the metal sheet (typical edge width of 10 mm) can be used, on the one hand, to secure the workpieces for removal and, on the other, as an engagement point for a removal device.

If a removal device for removing the compound engages the workpieces, at least two opposing nanojoints should then be attached to these workpieces. The weight of the compound to be removed is thus distributed to at least two nanojoints. The risk that they break prematurely is thereby reduced.

The engagement point(s) of the removal device are preferably positioned so that the compound to be removed cannot tilt during removal. The engagement point can lie in the center of gravity of the compound. In principle, one gripper is then sufficient. Two engagement points can lie in opposite corners of the compound or on opposite sides of an axis through the center of gravity of the compound. In these cases, at least two grippers are necessary.

The support for the metal sheet may have webs running parallel to one another. In this case, a workpiece which is narrower than a spacing between two adjacent webs of the support receives two connecting portions of low height at least when a narrow side of the workpiece is aligned transversely to the webs. In other words, two nanojoints are provided if the long side of the workpiece extends (approximately) parallel to the webs. The workpiece is typically at least 100 mm long. The slim workpiece is stabilized by the at least two nanojoints in the event that it is cut in a position at risk of tilting. A first of the connecting portions is preferably arranged on a narrow side of the workpiece. Preferably, a second of the connecting portions of low height is arranged on a long side of the workpiece—in particular, distanced by at least 60% of a length of the workpiece from the first connecting portion. In this way, the workpiece can be effectively stabilized. In particular, sagging of the workpiece can be avoided, which could make removal more difficult or impossible.

The separation in step D) can take place while a removal device used for removal in step C) directly or indirectly holds the workpiece. This can reduce the amount of equipment needed for separating the workpieces. In particular, additional devices for separating the workpiece from the adjoining part can be dispensed with if the removal device vibrates the compound with the workpiece to effect separation. A pressing out (pushing out) of the workpiece can also take place in a simple manner, while the removal device holds the compound with the workpiece. A movable push-out pin can be arranged at the removal device—in particular, at a gripper of the removal device.

Alternatively, the separation in step D) can take place after a removal device used for removal in step C) has released the workpiece—in particular, has deposited it on a separating device. This variant is suitable for groups of workpieces which do not contain a sheet skeleton part in their compound. The separating device can sort the workpieces for further processing.

Further features and advantages of the invention can be found in the claims, the description and the drawings. According to the invention, the aforementioned features and those which are to be explained below can each be used individually or as a plurality in expedient combinations of any kind. The embodiments shown and described are not to be understood as an exhaustive list, but, rather, have an exemplary character for the description of the invention.

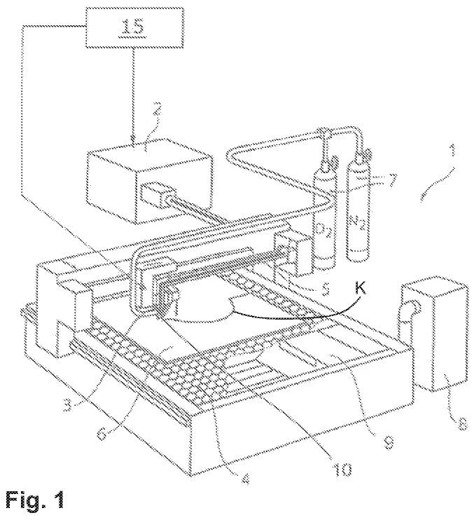

The laser cutting machine 1 shown in a perspective view in FIG. 1 has, for example, a CCV laser, a diode laser, or a solid-state laser as laser beam generator 2, a movable (laser) machining head 3, and a support 4. A laser beam 5 is generated in the laser beam generator 2, which laser beam is guided by means of a fiber optic cable (not shown) or deflection mirrors (not shown) from the laser beam generator 2 to the machining head 3. A metal sheet 6 is arranged on the support 4. The laser beam 5 is directed onto the metal sheet 6 by means of focusing optics arranged in the machining head 3. Furthermore, the laser cutting machine 1 is supplied with cutting gases 7—for example, oxygen and nitrogen. The use of the respective cutting gas 7 depends upon the material of the metal sheet 6 and upon quality requirements of the cutting edges. Furthermore, a suction device 8 is provided, which is connected to a suction channel 9 located below the support 4. The cutting gas 7 is supplied to a cutting gas nozzle 10 of the machining head 3, from which it exits together with the laser beam 5.

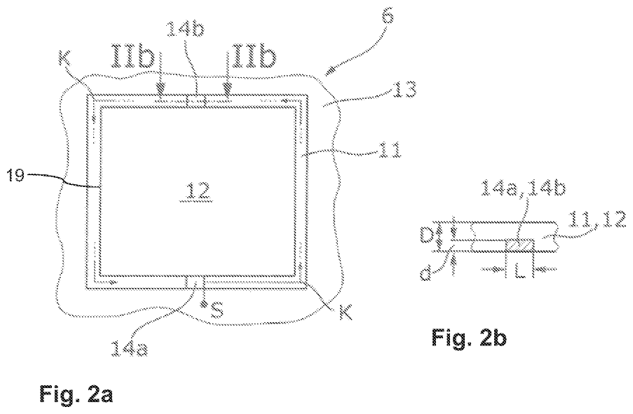

During laser cutting, the metal sheet 6 is cut along a desired path curve K which is part of an outline of a workpiece to be cut, by means of a laser beam 5 having a higher laser power (cutting power) sufficient for cutting through the metal sheet, wherein, in the present case, the laser beam 5—alternatively or additionally, however, also the metal sheet 6—is moved. For this purpose, the metal sheet 6 needs to be initially pierced on or next to the path curve K to be cut at a point S, as shown in FIG. 2a.

As shown in FIGS. 2a, 2b, during laser cutting of the metal sheet 6, in a kerf 11 between a laser-cut workpiece 12 and an adjoining part 13 of the metal sheet 6, connecting portions 14a, 14b, in the form of bridges or nanojoints, remain, which secure the workpiece 12 at the adjoining part 13 and thus prevent tilting relative to the adjoining part 13 or the support 4. In addition, due to the connecting portions 14a, 14b, the workpiece 12 and the adjoining part 13 can be handled together.

As shown in FIG. 2b, the nanojoint 14a, 14b does not extend over the entire thickness D of the metal sheet 6, but only in the lower third, and thus has a lower height d than the thickness D. The nanojoint is therefore also referred to here as a connecting portion 14a, 14b of low height. A length L of the nanojoint 14a, 14b along the kerf 11 is less than the thickness D; preferably the length L of the nanojoint 14a, 14b is less than half the thickness D.

In FIG. 2a, the nanojoint 14a is located at the end of the kerf, i.e., is produced shortly before the starting point S of the closed path curve K is reached again. In contrast, the nanojoint 14b is not located at the end of the kerf, but, rather, at an arbitrary part of the path curve K. The longitudinal area of the path curve K in which the nanojoints 14a, 14b are formed is here also referred to as a connection region of the outline 19 of the workpiece 12. The longitudinal area of the path curve K in which the metal sheet 6 is completely cut through is also referred to as a main region of the outline of the workpiece 12.

In the following, the production of the connecting portions 14a, 14b is described using the example of variation of the laser power. In this variant of the method, the nanojoints 14a, 14b are produced solely by selectively adjusting the laser power during the cutting process by means of suitably selected power gradients, which are specified by a control 15, shown in FIG. 1, of the laser cutting machine 1 as a function of the workpiece material. The control 15 also controls the movement of the machining head 3 relative to the metal sheet 6. Due to the lowered laser power, the cutting process no longer is supplied with the energy per length needed for a complete cut, so that the material is not melted over the complete thickness D of the metal sheet 6, and a nanojoint 14a, 14b remains between the laser-cut workpiece 12 and the adjoining part 13 in the lower region of the kerf 11 or the cutting edge.

With the exception of the laser power, all other cutting parameters of the laser cutting remain unchanged during the generation of the nanojoint 14a, 14b, i.e., for example, the focus position of the laser beam 5, the distance of the cutting gas nozzle 10 from the workpiece surface, the cutting gas pressure, and the cutting speed. After generating the nanojoint 14b, the standard parameters are used to continue cutting. After generating the nanojoint 14a, the laser beam 5 can be switched off. Alternatively, a further workpiece can be cut.

In order to produce the nanojoint 14b, which is not located at the end of the path curve K, with a lower height d than the workpiece thickness D, the laser power of the laser beam 5 is reduced from the higher laser power (cutting power) sufficient to cut through the metal sheet 6 to a lower laser power (reduced power), insufficient for the complete cutting through of the metal sheet 6, on a partial section of the path curve K corresponding to the length L of the nanojoint 14 during laser cutting of the metal sheet 6 and then again increased to the higher laser power (cutting power). During the processing with the low laser power (reduced power), a depression is produced in the metal sheet 6 above the nanojoints 14a, 14b.

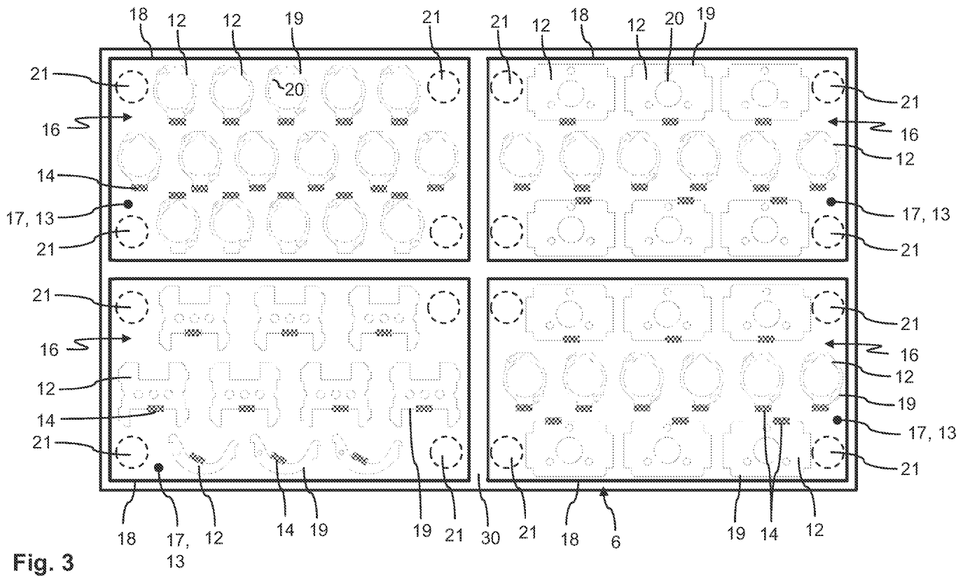

FIG. 3 shows a metal sheet 6 from which four groups 16 of workpieces 12 are cut. Each group 16 comprises a plurality of workpieces 12 and a sheet skeleton part 17 which represents an adjoining part 13 for the workpieces of the group 16. All workpieces 12 of a group 16 can be similar. Alternatively, a group 16 can contain different workpieces 12. The workpieces 12 of a group 16 are each connected to the associated skeleton part 17 via at least one nanojoint 14 (indicated abstractly by a checkerboard pattern). It is understood that the connecting portions 14 are designed to be smaller in practice than is schematically outlined here for reasons of visibility. The sheet skeleton parts 17 are each cut free from the metal sheet 6 along a circumferential contour 18. The sheet skeleton parts 17 are, by way of example, here rectangular.

The workpieces 12 may have cut inner contours 20 within their respective outline 19. With sufficiently large regions comprised by the inner contours 20, it is conceivable to cut further, smaller workpieces within the inner contours 20 and to connect them to the workpieces 12 via nanojoints (not shown in detail).

Engagement surfaces 21 for grippers of a removal device (not shown in detail) may be provided on the sheet skeleton parts 17. The engagement surfaces 21 can, for example, have a diameter of more than 120 mm. In the present case, the engagement surfaces 21 are arranged in corners of the sheet skeleton parts 17. No cutting lines are provided within the engagement surfaces 21. Vacuum grippers can therefore hold the sheet skeleton parts 17 in the region of the engagement surfaces 21 with vacuum. The corresponding sheet skeleton part 17 together with the workpieces 12 held thereon can then be removed from the remaining residual portion 30 of the metal sheet 6.

To separate the workpieces 12, the removal device can shake or vibrate (move rapidly back and forth) the corresponding sheet skeleton part 17. Due to the dynamic loads generated thereby, the connecting portions 14 break. The workpieces 12 fall out of the sheet skeleton part 17 and can be collected, for example, in a collection container. The weight loss when the workpieces 12 are removed can be measured by the removal device, so that the completeness of the separation can be checked.

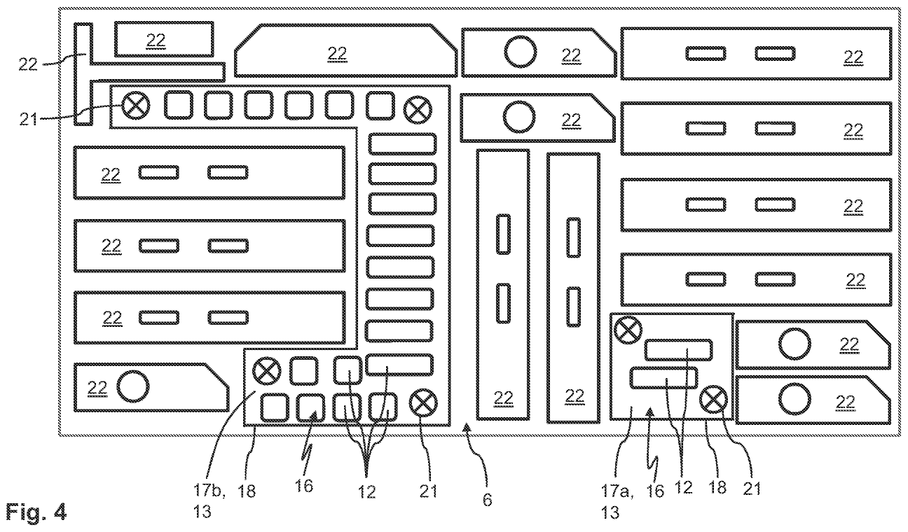

FIG. 4 shows a metal sheet 6 from which a plurality of larger sheet metal parts 22 and two groups 16 each having a plurality of smaller workpieces 12 have been cut. The sheet metal parts 22 are each completely cut free and are removed individually. The workpieces 12 of the two groups 16 are connected to a corresponding sheet skeleton part 17a, 17b via nanojoints (not shown in detail in FIG. 4) (cf. in this regard the above description for FIG. 3). The sheet skeleton parts 17a, 17b can in turn have engagement surfaces 21 for grippers of a removal device.

A circumferential contour 18 of the sheet skeleton part 17a arranged at the bottom in FIG. 4 is rectangular. Two engagement surfaces 21 can be provided in opposite corners.

The left-hand sheet skeleton part 17b in FIG. 4 has a complex contour 18. Here, the sheet skeleton part 17b is approximately C-shaped and has a concave portion. Engagement surfaces 21 can be provided in the region of the ends of the three legs of the C-shape.

The arrangement of the workpieces 12, which, in the groups 16, are connected to the corresponding sheet skeleton part 17a, 17b via nanojoints, is, in the present case, selected so that the area of the metal sheet 6 is used to produce the sheet metal parts 22 and the workpieces 12 to the greatest extent possible. The circumferential contours 18 of the sheet skeleton parts 17a, 17b have been selected so that the workpieces 12 are expediently combined in the groups 16.

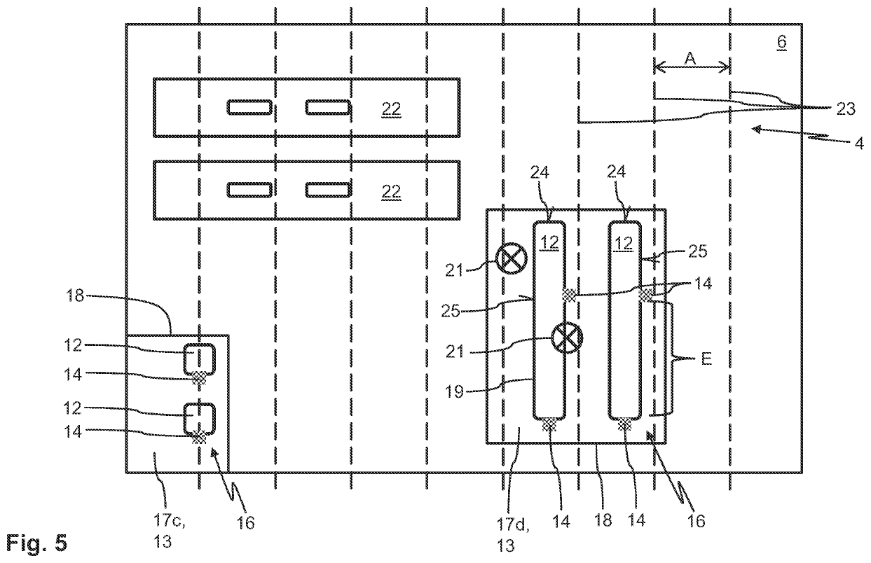

FIG. 5 shows a metal sheet 6, which rests on webs 23 of a support 4 of a laser cutting machine 1 (cf. FIG. 1), the webs 23 running parallel to one another. Two larger sheet metal parts 22 are completely cut free. Two groups 16 of a plurality of workpieces 12 are also shown here by way of example.

The group 16 shown on the bottom left in FIG. 5 comprises, by way of example, two small workpieces 12, which are connected to a sheet skeleton part 17c via one nanojoint 14 each. The sheet skeleton part 17c is arranged directly at the edge of the metal sheet 6. A contour 18 of the sheet skeleton part 17c extends between two outer sides of the metal sheet 6. The region, facing the edge, of the sheet skeleton part 17c can be used as an engagement surface for handling the compound of the two workpieces 12 and the sheet skeleton part 17c.

The group 16 shown on the right of the middle in FIG. 5 comprises, by way of example, two slim (elongated) workpieces 12, which are connected to a sheet skeleton part 17d via two nanojoints 14 each. Narrow sides 24 of the two workpieces 12 are shorter than a spacing A between adjacent webs 23 of the support 6. Even though long sides 25 of the two workpieces 12 are longer than the spacing A, the slim workpieces 12 could tilt or fall between the webs 23 in the present alignment with the long sides 25 running parallel to the webs 23. In order to prevent this, they are secured to the skeleton part 17d with the nanojoints 14. In each case, one of the nanojoints 14 is arranged on a narrow side 24. The second one of the nanojoints 14 is located on a long side 25, respectively. A distance E between the two nanojoints of a respective workpiece 12 can be at least two thirds of the length of the workpiece.

Engagement surfaces 21 for grippers of a removal device may be provided on the sheet skeleton part 17d. If the kerf along the outline 19 of the workpieces 12 is sufficiently narrow, then it is also conceivable for contact points 21 to extend both on one of the workpieces 12 and on the adjoining sheet skeleton part 17d.

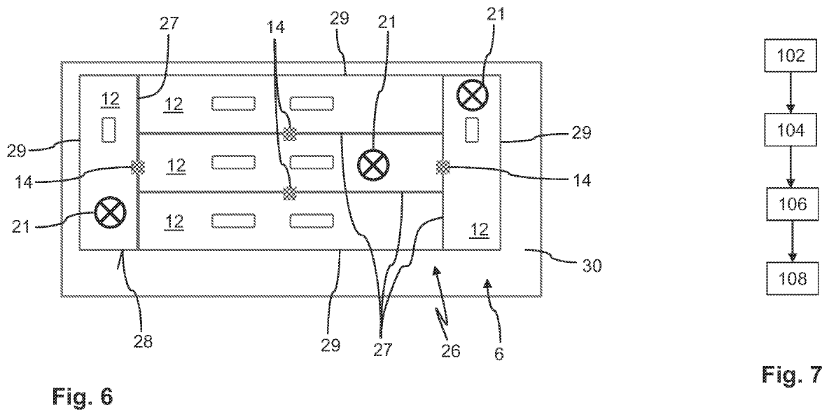

FIG. 6 shows a metal sheet 6 with a group 26 of workpieces 12 connected to one another via nanojoints 14. Adjacent workpieces 12 here have common outline lines 27. Along one of the common outline lines 27, at least two of the workpieces 12 each adjoin one another. The outline of each of the workpieces contains at least one of the common outline lines 27. Main regions of the common outline lines 27 are severed during cutting of the workpieces 12. In connection regions of the common outline lines 27, the nanojoints 14 remain. The workpieces 12 are held together via the nanojoints 14. The compound of the workpieces 12 connected directly to one another is also referred to here as a nest.

The group 26 of the workpieces 12 overall has a circumferential outer contour 28. The outer contour 28 is formed by free outline lines 29 of the workpieces 12. No further workpieces 12 of the group 26 adjoin the free outline lines 29. The free outline lines 29 are part of the outlines of the workpieces 12 arranged on the outside of the nest.

Along the outer contour 28, the metal sheet 6 is completely cut through. The group 26 can therefore be removed from a residual portion 30 of the metal sheet 6. For this purpose, grippers of a removal device can directly engage one or more of the workpieces 12. In FIG. 6, by way of example, three engagement surfaces 21 for vacuum grippers are marked, the engagement surfaces 21 approximately lying on a diagonal through the group 26. In order to separate the workpieces 12 from one another, the group 26 can be inserted into a separating device (not shown in detail), which separates the workpieces 12, after the removal device has released them.

FIG. 7 shows a summarizing flowchart of a method for cutting at least one workpiece—preferably a plurality of workpieces—from a metal sheet. In a step 102, the metal sheet is arranged on a support of a laser cutting machine.

Laser processing is then carried out in a step 104. For this purpose, a laser beam is directed onto the metal sheet. A point of incidence of the laser beam is moved along an outline of the at least one workpiece. In a main region of the outline of each workpiece, the metal sheet is completely cut through. In at least one connection region of the outline of each workpiece, the laser processing is controlled such that a connecting portion remains between the workpiece and an adjoining part of the metal sheet. This connecting portion has a height which is less than the thickness of the metal sheet. The laser power can be reduced to produce the connecting portion of low height (the so-called nanojoint). The adjoining part can be a further workpiece or a sheet skeleton part.

In a subsequent step 106, the compound of the at least one workpiece and of the adjoining part is removed from the support. A group of workpieces, which optionally comprises a sheet skeleton part, can have previously been cut free from a residual portion of the metal sheet in step 104.

Finally, in a step 108, the at least one workpiece is separated from the adjoining part. In particular, all workpieces of the group are separated from one another and an optionally present skeleton part.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

Laser cutting machine 1
Laser beam generator 2
Machining head 3
Support 4
Laser beam 5
Metal sheet 6
Cutting gases 7
Suction device 8
Suction channel 9
Cutting gas nozzle 10
Kerf 11
Workpiece 12
Adjoining part 13
Connecting portions (nanojoints) 14; 14a, 14b
Control 15
Group 16 with workpieces 12 and sheet skeleton part
Sheet skeleton part 17; 17a, 17b; 17c, 17d
Contour 18 of a sheet skeleton part
Outline 19
Inner contour 20
Engagement surfaces 21
Sheet metal parts 22
Webs 23
Narrow sides 24
Long sides 25
Group 26 of workpieces 12 connected to one another
Common outline lines 27
External contour 28
Free outline lines 29
Residual portion 30
Path curve K
Piercing point S
Thickness D of metal sheet 6
Height d of connecting portions 14; 14a, 14b
Length L of connecting portions 14; 14a, 14b
Spacing A between webs 23
Distance E
Arranging 102
Laser processing 104
Removal 106
Separation 108

1. A method for cutting at least one workpiece from a metal sheet, the method comprising:
A) arranging a metal sheet on a support of a laser cutting machine;
B) directing a laser beam onto the metal sheet along an outline of the workpiece, wherein the metal sheet is cut through in a main region of the outline, and wherein at least one connecting portion, which has a height that is less than a thickness of the metal sheet, remains in at least one connection region of the outline between the workpiece and an adjoining part of the metal sheet;
C) removing the at least one workpiece and the adjoining part connected thereto from the support; and
D) separating the at least one workpiece from the adjoining part.

2. The method according to claim 1, wherein the height of the connecting portion is at most one third of the thickness of the metal sheet.

3. The method according to claim 1, wherein a length of the connecting portion measured along the outline is at most half of the thickness of the metal sheet.

4. The method according to claim 1, wherein, in step B), a group of workpieces is formed which are connected to one another by connecting portions at at least one common outline line of the workpieces.

5. The method according to claim 4, wherein the group of workpieces has a circumferential outer contour, which is formed by outline lines of the workpieces, along which the metal sheet is cut through.

6. The method according to claim 4, wherein, in step C), a removal device engages one workpiece of the group of workpieces.

7. The method according to claim 1, wherein,
in step B), a group of workpieces is formed, wherein each workpiece of the group of workpieces remains connected to a common sheet skeleton part via the at least one connecting portion, and
in step C), the group of workpieces and the sheet skeleton part are removed jointly.

8. The method according to claim 7, wherein the sheet skeleton part is cut free from the metal sheet prior to step C) along a circumferential contour.

9. The method according to claim 8, wherein the circumferential contour is concave.

10. The method according to claim 8, wherein a smallest distance of the circumferential contour from the group of workpieces is at least 12 mm, and/or on the sheet skeleton part, at least one engagement surface for a removal device of at least 120 mm in diameter remains free of the group of workpieces.

11. The method according to claim 10, wherein the smallest distance of the circumferential contour from the group of workpieces is greater than the thickness of the metal sheet.

12. The method according to claim 7, wherein, in step C), a removal device engages the sheet skeleton part.

13. The method according to claim 1, wherein the support comprises webs running in parallel, the workpiece is narrower than a spacing between two adjacent webs, the workpiece receives two connecting portions, wherein a first connecting portion of the two connecting portions is arranged on a narrow side of the workpiece, and a second connecting portion of the two connecting portions is arranged on a long side of the workpiece.

14. The method according to claim 13, wherein the second connecting portion is distanced from the first connecting portion by at least 60% of a length of the workpiece.

15. The method according to claim 1, wherein a removal device is used for the removal in step C), wherein the removal device comprises a vacuum gripper, a magnet gripper, a Bernoulli gripper, and/or a mechanical gripper.

16. The method according to claim 1, wherein the separation in step D) is performed by vibrating, pressing, blowing out, or pulling.

17. The method according to claim 16, wherein the pulling comprises magnetic pulling or pulling by a negative pressure.

18. The method according to claim 1, wherein the separation in step D) is performed while a removal device used for the removal in step C) indirectly or directly holds the workpiece.

19. The method according to claim 1, wherein the separation in step D) is performed after a removal device used for the removal in step C) has released the workpiece.

20. The method according to claim 19, wherein the separation in step D) is performed after the removal device has deposited the workpiece on a separating device.
